(19) United States
(12) Patent Application Publication
(10) Pub. No.: US 2019/0199585 A1
(43) Pub. Date: Jun. 27, 2019

(54) System and method to configure a user device

(71) Applicant: Comptel Oy, Helsinki (FI)

(72) Inventors: Timo SIMILÄ, Helsinki (FI); Leo WIKSTRÖM, Helsinki (FI)

(73) Assignee: Comptel Oy, Helsinki (FI)

(21) Appl. No.: 15/851,790

(22) Filed: Dec. 22, 2017

(51) Int. Cl. H04L 12/24; H04L 29/08

(52) U.S. Cl. CPC H04L 41/0806; H04L 67/22; H04L 41/0853

(57) ABSTRACT

The invention relates to a configuration system to configure a user device, which configuration system is arranged to be connectable to the user device through a communication network, wherein the configuration system comprises an analytic module and an execution module. The analytic module is arranged to analyse user operations information, and to form a configuration for a scenario of user operations utilizing the analysed user operations. The execution module is arranged to compare the user operations information with the scenario, and to provide a configuration suggestion to a user of the user device if the user operations information corresponds with the scenario, and to execute the configuration suggestion.

### FIELD OF TECHNOLOGY

The invention relates to a system and a method to configure a user device like a mobile phone, tablet, laptop, computer or any configurable device. The user device is connectable to a communication network like a mobile communication network.

### BACKGROUND

When configuring a user device, for example, a mobile phone, the properties of the user device are taken into account. Suitable applications are also configured to be used on the device. It is also common to provide an opportunity to a user to select some features of an application to be configured. Further the user may download new applications from service providers through a communication network. In addition, some features of the user device may not be active, so the user may be required to accept certain configuration in order to active them.

So, a user device can be configured as desired by the user of the device. However, there are situations where configuration possibilities are not so good or are quite restricted. Those situations occur especially when a user is going to use or to need a new product.

### SUMMARY OF THE INVENTION

The object of the invention is to alleviate or even eliminate the problems said above. The idea of the invention is to make it possible to the user of a device to configure the device as soon as possible when the new product is enabled or when the need for a new product is detected.

The object is achieved in a way described in the independent claims. Dependent claims illustrate different embodiments of the invention.

A configuration system to configure a user device according to the invention is arranged to be connectable to the user device through a communication network. The configuration system comprises an analytic module and an execution module. The analytic module is arranged to receive user operations information and to analyse the received user operations information. The analytic module is also provided with a scenario/s of user operations, and arranged to form a configuration for the scenario utilizing the analysed user operations. The execution module is arranged to receive user operations information, to compare the received user operations information with the scenario, to provide a configuration suggestion to a user of the user device if the user operations information corresponds with the scenario, and to execute the configuration suggestion if an approval is received.

### SHORT DESCRIPTION OF THE DRAWINGS

In the following, the invention is described in more detail by reference to the enclosed drawings, where

FIG. 1 illustrates an example of a configuration system according to the invention being in connection with a user device through a communication network,

FIG. 2 illustrates an example of configuration system in more detail, and

FIG. 3 illustrates an example of a flow chart showing a method according to the invention.

### DESCRIPTION OF THE INVENTION

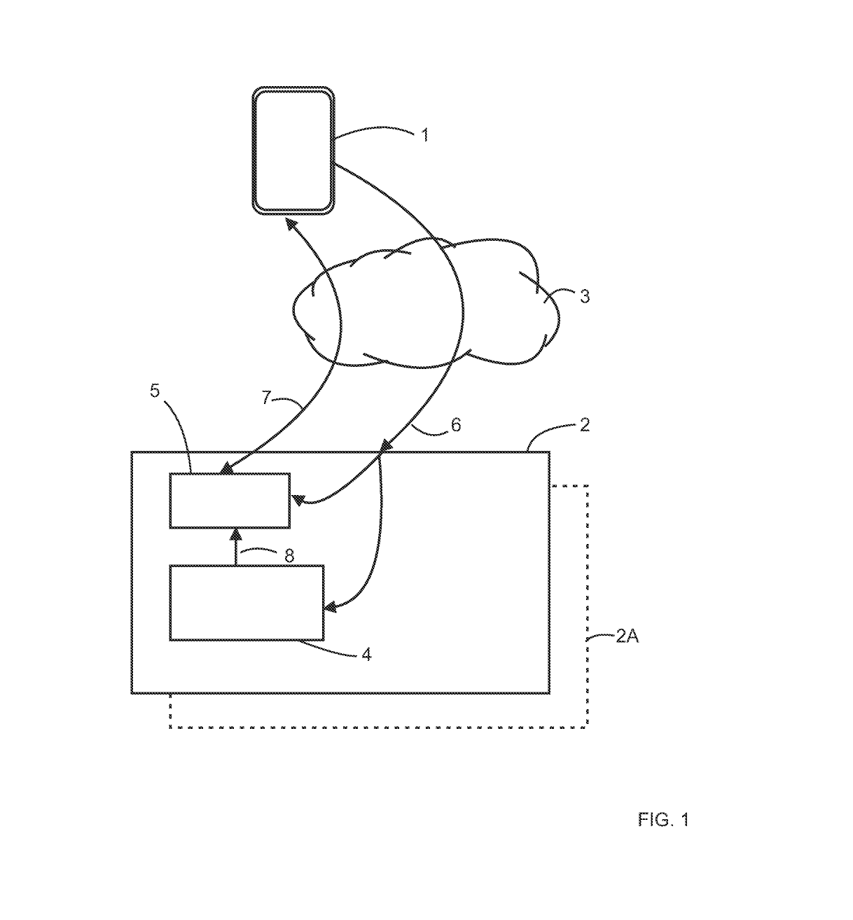

FIG. 1 illustrates an example of a configuration system according to the invention being in connection with a user device 1 through a communication network 3. So, the configuration system is arranged to be connectable to the user device 1. The configuration system comprises an analytic module 4 and an execution module 5.

The analytic module 4 is arranged to receive 6 user operations information and to analyse the received user operations information. The user operations information is transmitted through the communication network 3, which is a mobile communication network in the example of FIG. 1, since the user device 1 is a mobile phone in this example. However, the communication network can also be any communication network comprising wires of copper, optical fibres etc.

The analytic module 4 is also provided with a scenario of user operations, and arranged to form a configuration for the scenario utilizing the analysed user operations. The scenario can, for example, be that a user has replaced his 3G mobile phone with a new 4G mobile phone. Although the applications of the old 3D mobile phone run also on the new 4G mobile phone, there can be updated applications or new applications, which run much better on the new phone than the current applications. So, in the new context a configuration can be useful in order to provide better applications and services to the user. The configuration can replace the current applications with updated applications or new applications.

The execution module 5 is also arranged to receive 6 user operations information. Further, the execution module 5 is arranged to compare the received user operations information with the scenario. If the user operations information corresponds with the scenario the execution module provides a configuration suggestion to the user of the user device. In the case of the scenario to change the old 3G phone to a new 4G phone the received user information reveals that the phone is the 4G phone. The comparison function finds the scenario of the change of a 3G phone to a 4G phone, so the received user operations information corresponds with the scenario, and the execution module 5 provides a configuration suggestion to the user. If an approval is received by the execution module, the execution module executes the configuration suggestion.

So, the scenario is a new product, which is not currently used. The new product can be a new user device like a mobile phone, a tablet or a laptop, or a new application. So, several scenarios can be provided, like the change of a 3G phone to a 4G phone, the change of a 2G phone to a 4G phone, the change of a certain tablet to a certain more powerful tablet, etc.

The user operations can comprise calls, use of applications, data use, etc. The received user operations information may reveal the use of new product as can be seen above. The received user operations information may also reveal needs for new products, like new applications.

As said the received user operations information is analysed, and the analytic module is also provided with scenarios of user operations. The analysed user operations information and the scenarios are used to form configurations for the scenarios, which may occur within a user device. So, the scenarios are new contexts comprising circumstances and behaviour of a user. The analyses of the user operations information are performed using suitable algorithms. For example, the analyse may reveal that the user has begun to use more video services on regular basis, so this analyse can be used to form a configuration for a certain scenario relating to video services. The analysed user operations information can also be used to provide a scenario. So, the configurations are made for scenarios, which do not exist, but may exit in the future.

The analyse of the user operations information reveals also what kind of configurations are useful to be formed. For example, if the analyse reveals that the user has changed his or her behaviour to consume less data when using a certain application, it can be deduced that there is no need for a configuration to suggest a more powerful application capable to handle huge amount of data, but instead there can be a need for an application, which can handle the use with minor data amount, and at the same time releasing resources of the user device for other purposes and applications. So, the analytic module 4 provides 8 the scenarios and the configurations to the execution module 5, which in turn communicate 7 with the user device in order to execute the configurations. In some embodiments user's approval maybe requested before executing the configurations. So, when executing a configuration, an approval is requested from user by the execution module. If the approval is received, the execution of the configuration is made to the end.

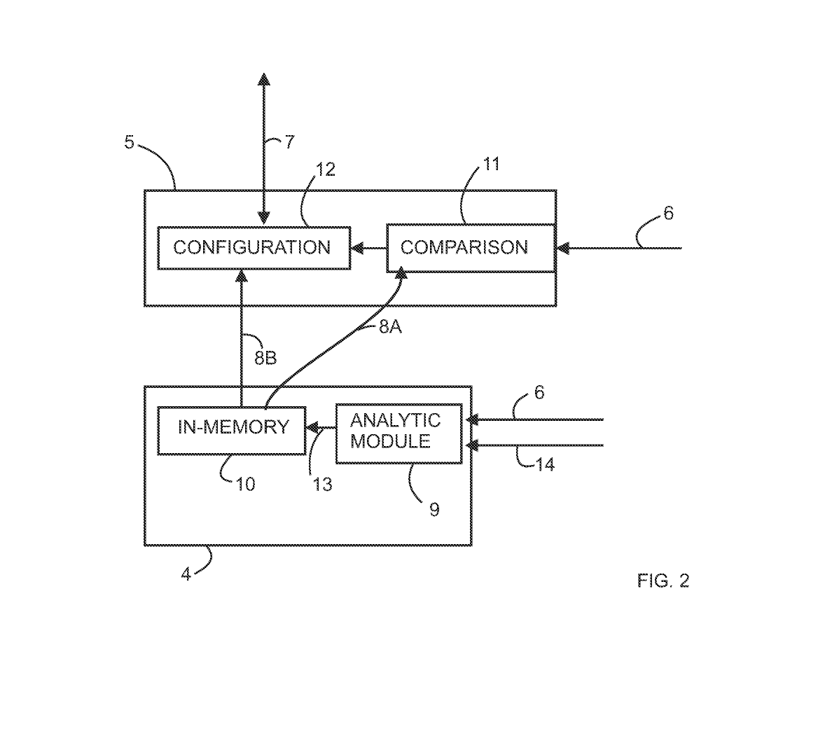

So, the execution of the configuration is made to the end. The configuration is transmitted 7 to the user device 1. In practice a configuration can be a configuration file in a memory 10, see FIG. 2, which contain configuration information. The configuration information may contain all information for the execution or a part of the configuration information. The part of the configuration information may, for example, be a setup file having instructions to download an actual new application from a service provider.

The example of FIG. 1 shows that the configuration system 4, 5 is situated to a central server site 2. The central server site can at a premises of network operator, so it can be installed to be in connection with the operator's systems. This solution can be convenient, because then it easy to handle the configuration system with other systems that handle customer information. For example, it is convenient to use the configuration system with customers who have allowed to use it. Also, the distribution of the received 6 user device information to the analytic module 4 and the execution module 5 can be arranged easily. The server site can also be distributed 2A, so also the configuration system can be distributed to several sites. It is worth noting that the configuration system can be located to any suitable site such as a service provides site.

The execution module 5 is arranged to run real time or almost real time. In this description the expression “almost real time” covers latencies from very short periods of hundreds of ms to several minutes, which in many cases means in practise that the received user information represents real time information. So, the configuration system according to the invention can react very fast for a new context occurring on a user device, and transmit a configuration suggestion to the user device in order to execute the configuration.

On the other hand, the analytic module 4 can be arranged to process its functions with several hours. In this way good and precise configurations can be obtained. The analytic module processes a huge amount of data received from the user devices within a relatively long period. It may also handle older historical and statistical data. A period of several hours, for example 12 hours, makes it possible to form accurate configurations for different scenarios. In other words, suitable configurations for each user device are predicted for the future contexts. The configurations are arranged to be accessible to the execution module.

FIG. 2 illustrates an example of a configuration system 4, 5 in more detail. The analytic module 4 comprises an analysing unit 9 and a memory 10. The analysing unit is arranged to analyse the received user operations information, and to form the configurations for the scenarios utilizing the analysed user operations as already described above. The configurations are transmitted 13 into the memory 10 where they are kept for the use of the execution module 5. The memory can be an in-memory, which is faster than a traditional memory. As an input, the analytic module 4, more precisely the analytic unit 9 in the example of FIG. 2, can receive 6 user operations information and to receive 14 other information like scenarios, general historical data or statistics relating to users behaviour, applications, different user devices etc. The analytic module can also be arranged to perform historical data and statistics from the received user device information.

The execution module 5 comprises a comparison unit 11 to compare the received user operations information with scenarios, and the configuration unit 12 to provide already said configuration suggestion and to execute the configuration suggestion. As showed in FIG. 2 the execution module is arranged to receive the scenarios transmitted 8A from the analytic module 4, and to receive the configurations transmitted 8B from the analytic module 4, more precisely from the memory 10. The transmissions 8A and 8B in FIG. 2 are showed as one line 8 in FIG. 1.

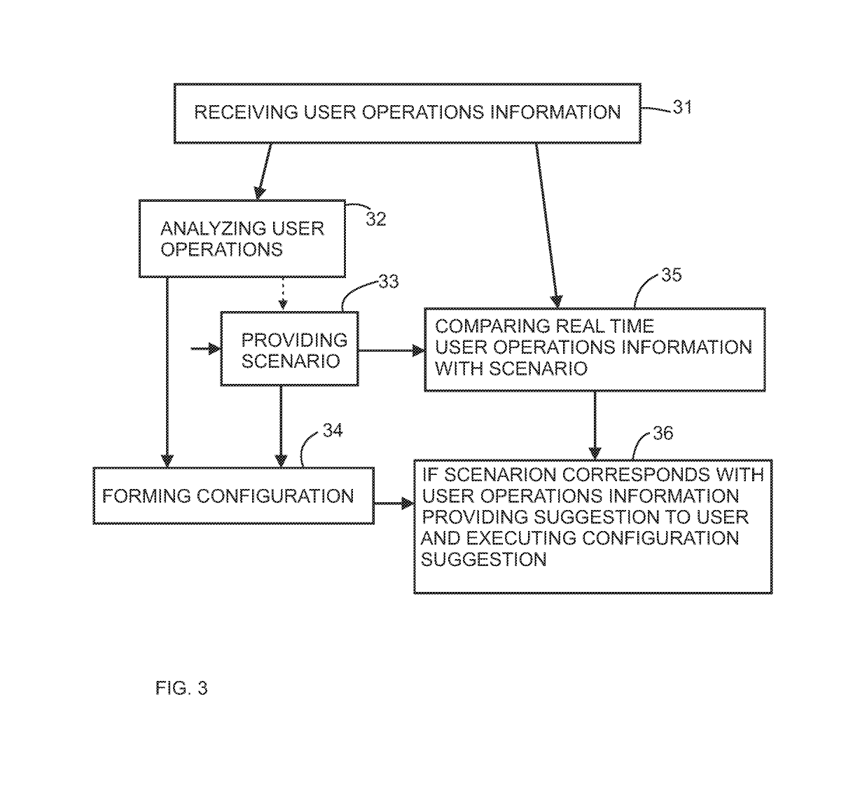

FIG. 3 shows an example of a flow chart illustrating the inventive method. The method for configuring a user device being connectable through a communication network comprises several steps. User operations information is received 31, which information is used directly in two other steps as showed in FIG. 3. The received user operations information is analysed 32, and a scenario or scenarios of user operation is/are provided 33. The analysed information and the scenarios are used when forming 34 a configuration for the scenario. The scenario/s can be provided by utilizing the analysed information or it can be transmitted outside into the system, or it can be a predetermined scenario in the system. Here, the system refers to the above described system, like in FIGS. 1 and 2. So, the method is used within the inventive configuration system.

The received user operations information is compared 35 with the scenario/s. If the user operations information corresponds with the scenario, a configuration suggestion is provided 36 to the user of the user device, and executed. If in some other embodiments an approval for the configuration suggestion can be received and then the configuration suggestion is executed in order to realize the configuration on the user device. It is worth noting that in this description the configuration covers also re-configurations as well.

With respect to the inventive method it is clear from the above text that the scenario is a new product, which is not currently used, several scenarios can be provided, and user operations comprise calls, use of applications, and data use. Further, the scenario or new product can be another context with a business opportunity, which is likely to occur in the future. For example, the scenario can be any context with a business opportunity like a user in a certain location, a user consuming certain content, a user having quality of service issues etc.

The inventive system can be provided in different ways like using special hardware, software or both. Software utilization is convenient as it can be installed on one or more computer-readable storage media. So the invention can be performed as on one or more computer-readable storage media comprising a plurality of instructions that in response to being executed cause a computing device to receive user operations information; to analyse the received user operations information; to provide a scenario of user operation; to forming a configuration for the scenario utilizing the analysed user operations; to comparing the received user operations information with the scenario; to provide a configuration suggestion, if the user operations information corresponds with the scenario; and to execute the configuration suggestion if an approval for the configuration suggestion is received.

As can be noted the invention makes it possible to provide a configuration for a user device fast when a new device or application is put into use. Therefore, the user of the device can get the benefits of the new context into the use very fast. The configuration system can be arranged to run within a mobile communication network or other type of communication network. Although, the invention evidently relates to the configurations of the mobile user devices, the invention can be implemented for other type of user devices like desktop computers. The new products within the new contexts, which are configured may relate to any service that can be handled through a communication network or any service that utilizes a communication network, like following services of seniors etc.

It is evident from the above that the invention is not limited to the embodiments described in this text but can be implemented in many other different embodiments within the scope of the independent claims.

1. A configuration system to configure a user device, which configuration system is arranged to be connectable to the user device through a communication network, wherein the configuration system comprises an analytic module and an execution module,
which analytic module is arranged to receive user operations information and to analyse the received user operations information, and the analytic module is also provided with a scenario of user operations, and arranged to form a configuration for the scenario utilizing the analysed user operations, and
which execution module is arranged to receive user operations information, to compare the received user operations information with the scenario, to provide a configuration suggestion to a user of the user device if the user operations information corresponds with the scenario, and to execute the configuration suggestion if an approval is received.

2. The configuration system of claim 1, wherein the scenario is a new product, which is not currently used, or another context with a business opportunity, which is likely to occur in the future.

3. The configuration system of claim 2, wherein several scenarios are provided.

4. The configuration system of claim 3, wherein the analytic module is arranged to utilize the analysed user operations to provide the scenario.

5. The configuration system of claim 3 or 4, wherein the execution module is arranged to run real time or almost real time.

6. The configuration system of claim 5, wherein the analytic module is arranged to process its functions with several hours.

7. The configuration system of claim 6, wherein the analytic module comprises an analysing unit and a memory, the analysing unit being arranged to analyse the received user operations information, and to form said configuration for the scenario utilizing the analysed user operations,
and the execution module comprises a comparison unit to compare the received user operations information with the scenario, and the configuration unit to provide said configuration suggestion and to execute said configuration suggestion.

8. The configuration system of claim 7, wherein the configuration system is arranged to be situated at a network operator site.

9. The configuration system of claim 8, wherein said new product is a new user device like a mobile phone, a tablet or a laptop, a new application, or any context with a business opportunity like a user in a certain location, a user consuming certain content, a user having quality of service issues′

10. The configuration system of claim 9, wherein said user operations comprises calls, use of applications, and data use.

11. The configuration system of claim 10, wherein the configuration system is arranged to run within a mobile communication network.

12. A method for configuring a user device being connectable through a communication network, the method comprising:
receiving user operations information;
analysing the received user operations information;
providing a scenario of user operation;
forming a configuration for the scenario utilizing the analysed user operations;
comparing the received user operations information with the scenario;
providing a configuration suggestion, if the user operations information corresponds with the scenario; and
executing the configuration suggestion.

13. The method of claim 12, wherein the scenario is a new product, which is not currently used, or another context with a business opportunity, which is likely to occur in the future.

14. The method of claim 13, wherein several scenarios are provided

15. The method of claim 14, wherein the analysed user operations are utilized to provide the scenario.

16. The method of claim 15, wherein said user operations comprises calls, use of applications, and data use.

17. One or more computer-readable storage media comprising a plurality of instructions that in response to being executed cause a computing device to:
receiving user operations information;
analysing the received user operations information;
providing a scenario of user operation;
forming a configuration for the scenario utilizing the analysed user operations;
comparing the received user operations information with the scenario;
providing a configuration suggestion, if the user operations information corresponds with the scenario; and
executing the configuration suggestion.
